(19) United States
(12) Patent Application Publication
(10) Pub. No.: US 2011/0055689 A1
(43) Pub. Date: Mar. 3, 2011

(54) METHOD OF PERFORMING AT LEAST ONE OPERATION IN IMAGE FORMING APPARATUS, AND IMAGE FORMING APPARATUS AND HOST DEVICE TO PERFORM THE METHOD

(75) Inventors: Chi-tack CHANG, Suwon-si (KR); Kee-chang Lee, Hwaseong-si (KR); Seong-il Park, Seoul (KR)

(73) Assignee: Samsung Electronics Co., Ltd, Suwon-si (KR)

(21) Appl. No.: 12/872,122

(22) Filed: Aug. 31, 2010

(30) Foreign Application Priority Data
Aug. 31, 2009 (KR) 10-2009-0081655

(51) Int. Cl. G06F 17/00; G06F 21/00

(52) U.S. Cl. 715/255; 715/273; 726/27

(57) ABSTRACT

A method of performing at least one operation in an image forming apparatus, the image forming apparatus to perform the method, and a host device. In the method, at least one operation is performed using a workform in an image forming apparatus that can be connected to a host device, the method including selecting a document to be processed, receiving user identification information from a user who is to perform the at least one operation on the document, receiving at least one workform corresponding to the user identification information from the image forming apparatus, and performing an operation according to the received workform on the document in the image forming apparatus.

### CROSS-REFERENCE TO RELATED APPLICATIONS

This application claims priority under 35 U.S.C. §119(a) from Korean Patent Application No. 10-2009-0081655, filed on Aug. 31, 2009, in the Korean Intellectual Property Office, the disclosure of which is incorporated herein in its entirety by reference.

### BACKGROUND

1. Field of the Invention

One or more embodiments of the present general inventive concept relate to a method of performing at least one operation in an image forming apparatus, and the image forming apparatus and a host device to perform the method.

2. Description of the Related Art

Image forming apparatuses perform at least one operation, such as printing, copying, scanning, transmitting/receiving a facsimile message, sending an email message, transmitting data to a server, and so on. A user should input commands for respectively performing such a plurality of operations in order to perform them by using an image forming apparatus. The plurality of operations may be performed in the image forming apparatus by inputting the commands by either manipulating the image forming apparatus or by using a host device.

### SUMMARY

One or more embodiments of the present general inventive concept provide a method of performing at least one operation in an image forming apparatus, and an image forming apparatus and a host device to perform the method. However, the present general inventive concept is not limited to these embodiments.

Additional features and utilities of the present general inventive concept will be set forth in part in the description which follows and, in part, will be obvious from the description, or may be learned by practice of the general inventive concept.

Exemplary embodiments of the present general inventive concept may provide a method of performing at least one operation by using a workform that defines a workflow indicating a list of operations to be performed in an image forming apparatus that is to be connected to a host device, the method including selecting a document to be processed, receiving user identification information of who is to perform the at least one operation on the selected document, receiving at least one workform corresponding to the received identification information from the image forming apparatus; displaying the received at least one workform, selecting at least one workform from among the displayed at least one workform, according to received information, and performing an operation according to a workflow defined in the selected at least one workform on the document in the image forming apparatus.

Exemplary embodiments of the present general inventive concept may also provide an image forming apparatus to perform at least one operation by using a workform that defines a workflow indicating a list of operations to be performed, the image forming apparatus including a storage unit to store a plurality of pieces of identification information of a plurality of respective users and workforms corresponding to the pieces of the identification information, a communication interface unit to receive user identification information of a user who is to perform the at least one operation, and to transmit at least one workform corresponding to the received identification information from among the stored workforms, a controller to control an operation according to a workflow defined in at least one workform selected from among the transmitted at least one workform, and an operation performing unit to perform the operation on a document to be processed, under control of the controller.

Exemplary embodiments of the present general inventive concept may also provide a host device to control an image forming apparatus which performs at least one operation by using a workform that defines a workflow indicating a list of operations to be performed, the host device including a user interface unit to receive user identification information from a user who is to perform the at least one operation, and to display at least one workform corresponding to the received user identification information, a processor to execute a printer driver of the image forming apparatus, and to select a document, which is to be processed, and at least one workform from among the displayed at least one workform, according to received information, and a communication interface unit to transmit a command that instructs an operation be performed on the selected document according to a workflow defined in the selected at least one workform.

Exemplary embodiments of the present general inventive concept may also provide a method of performing a least one operation with an image forming apparatus, the method including receiving a selection to generate at least one workform that includes a workflow of one or more operations to be performed by at least the image forming apparatus, receiving at least one of an add, modify, and delete command to edit the one or more operations of the workflow included in the generated workform, receiving a selection of a document with the image forming apparatus, performing the one or more operations included in the edited workflow of the selected workform on the selected document.

Exemplary embodiments of the present general inventive concept may also provide a method of controlling a least one operation of an image forming apparatus with a host apparatus, the method including receiving a selection of a document with the host apparatus, receiving a selection of at least one workform that includes a workflow of one or more operations with the host apparatus to be performed by at least the image forming apparatus, and controlling the image forming apparatus with the host apparatus to perform the one or more operations included in the workflow of the selected workform on the selected document.

Exemplary embodiments of the present general inventive concept also provide a method of controlling an image forming apparatus to perform one or more operations, the method including receiving a list of workforms with a communication interface of the image forming apparatus, performing one or more operations with an operation performing unit of the image forming apparatus, and controlling the operation performing unit with a control unit to perform subsequent operations of the respective workforms according to the list.

### BRIEF DESCRIPTION OF THE DRAWINGS

The above and other features and utilities of the present general inventive concept will become more apparent by describing in detail exemplary embodiments thereof with reference to the attached drawings in which:

FIG. 1 is a block diagram illustrating an image forming system according to exemplary embodiments of the present general inventive concept;

FIG. 2 illustrates an example of a user interface screen to provide a plurality of workforms according to exemplary embodiments of the present general inventive concept;

FIG. 3 illustrates an example of a user interface screen in which a plurality of workforms are edited according to exemplary embodiments of the present general inventive concept;

FIG. 4 illustrates a graphics user interface (GUI) of the image forming apparatus of FIG. 1, via which a workform is created according to exemplary embodiments of the present general inventive concept;

FIG. 5 illustrates an example of a GUI of the image forming apparatus of FIG. 1, in which an input type of data to perform operations defined in a workform is selected according to exemplary embodiments of the present general inventive concept;

FIG. 6 illustrates an example of a GUI of the image forming apparatus of FIG. 1, in which an output module of data to perform operations defined in a workform is selected according to example embodiments of the present general inventive concept;

FIG. 7 illustrates a database of user identification information and a database of workforms according to exemplary embodiments of the present general inventive concept;

FIG. 8 illustrates the syntax of a program to generate a workform according to exemplary embodiments of the present general inventive concept; and

FIG. 9 is a flowchart illustrating a method of performing at least one operation in an image forming apparatus according to exemplary embodiments of the present general inventive concept.

### DETAILED DESCRIPTION OF THE EMBODIMENTS

The present general inventive concept will now be described more fully with reference to the accompanying drawings, in which exemplary embodiments of the present general inventive concept are illustrated. The embodiments are described below in order to explain the present general inventive concept by referring to the figures.

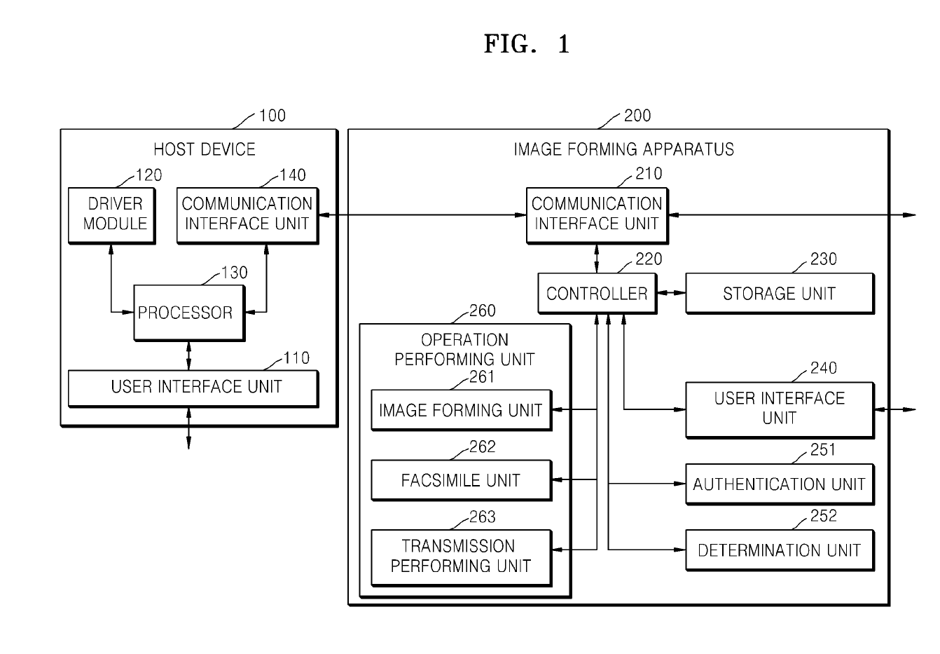

FIG. 1 is a block diagram of an image forming system according to exemplary embodiments of the present general inventive concept. Referring to FIG. 1, the image forming system according to exemplary embodiment can include an image forming apparatus 200 and a host device 100. Although FIG. 1 illustrates that the image forming system includes one host device 100 and one image forming apparatus 200, the image forming apparatus 200 may be connected to a plurality of host devices 100. For example, the image forming apparatus 200 may be communicatively coupled to wired and/or wireless communications network, where a plurality of host devices may be communicatively coupled to the communications network. That is, the image forming apparatus 200 and one or more host devices may transmit and receive data, commands, instructions, and/or other information amongst each other via the wired and/or wireless communication network.

In the present specification, elements related to the exemplary embodiments have been described in order to minimize the obscuring of the features thereof. Thus, it would be apparent to those of ordinary skill in the art that the image forming system according to the exemplary embodiments may further include general elements other than the elements illustrated in FIG. 1.

Referring to FIG. 1, the host device 100 can include a user interface unit 110, a driver module 120, a processor 130, and a communication interface unit 140. The host device 100 can control the image forming apparatus 200, and may be any device, e.g., a general computer system, server, processor, programmable gate array, cell phone, smartphone, tablet computing device, and/or a personal digital assistant, which can be connected to the image forming apparatus 200 to control the image forming apparatus 200.

The user interface unit 110 can receive an input signal and/or input selection from a user and can display output information so that the user can view it. For example, if the host device 100 is a general computer system, the user interface unit 110 may be an input/output device, such as a mouse, a keyboard, a touch screen, a display, an image forming apparatus, and/or a speaker.

The user can select a document to be processed by manipulating the user interface unit 110, and can input user identification information. That is, the user interface unit 110 can receive user identification information input and one or more selections of one or more documents to be processed. The user interface unit 110 can display at least one workform corresponding to the received identification information, and the user can select at least one workform from among the displayed at least one workform by manipulating the user interface unit 110.

The workform can be a workflow indicating a list of a plurality of operations to be performed in the image forming apparatus 200. For example, the workform can be defined such that at least one operation selected by a user from among a plurality of operations (e.g., printing, copying, sending an email message, transmitting data to a server, etc.) which can be performed by the image forming apparatus 200 is performed. For example, the workform can define in the form of a file a workflow that indicates a plurality of operations to print ten copies of print data received from the host device 100, to attach the print data to an email message, and/or to send the email message to a predetermined email address. The workform will be described in greater detail below in connection with the image forming apparatus 200.

A user may perform a plurality of operations by using workforms each defining a workflow of operations that are frequently performed. Alternatively, the user interface 110 may receive one or more selections from a user for one or more workforms, where each of the workforms may define a workflow of operations to control the image forming apparatus 200. As described above, it is possible to minimize and/or prevent inconvenience that may be caused by setting print commands to print the print data and email sending commands to attach the print data to an email message and to input an email address whenever the print data is to be printed and to be sent via email. That is, the user may conveniently perform a plurality of operations by selecting one of preset workforms by using the user interface unit 110 of the host device 100. The user interface 110 may receive one or more selections from a user and perform one or more operations according to the received selections of workforms.

A user can select a document to be processed by manipulating the user interface unit 110. The user may select a document to be processed by using an application program that is installed and executed in the host device 100. Examples of the application program include Microsoft® Word®, Microsoft® PowerPoint®, Microsoft® Excel®, Adobe® PhotoShop®, and Drawing Tool, which can be used with the image forming apparatus 100 (e.g., the host apparatus 100 can generate one or more documents with the example application programs to be printed, faxed, emailed, stored, and/or displayed by the image forming apparatus 200). The user can execute the application program, open the document, and executes a printer driver to perform a desired operation by using the image forming apparatus 200. The user may execute the printer driver, for example, by selecting a printer icon with, for example, the user interface unit 110. The printer driver can be executed according to an operation command received from the user, and the printer driver can display a user interface screen to set printing options on the user interface unit 110.

A user can input the user identification information by manipulating the user interface unit 110 (e.g., the user identification information may be received by the user interface unit 110). The user identification information may be input using the printer driver, the application program, and/or the user interface unit 110. That is, the user identification information may be input using the printer driver to set printing options or when the application program is executed. The user identification information can be user authentication information that is set and associated with the image forming apparatus 200. The user may register an identifier (ID) and password, which are examples of the user identification information, with the image forming apparatus 200. The image forming apparatus 200 can store registered user identification information, and the stored user identification information can be mapped to workforms. The user can input the user identification information by manipulating the user interface unit 110, transmitting the user identification information to the image forming apparatus 200 with the communication interface unit 140, and receiving at least one workform corresponding to the user identification information from the image forming apparatus 200.

The at least one workform received from the image forming apparatus 200 can include at least one selected from a list of workforms, which is mapped to the user identification information from among a plurality of lists of workforms stored in the image forming apparatus 200, and a workform that can be created and/or modified, and is stored by the user.

A user may transmit to the image forming apparatus 200 via the communication interface unit 140 commands to instruct that an operation be performed according to a workflow defined in a workform by selecting one of the at least one workforms displayed on the user interface unit 110.

The above operations that can be performed by the user interface unit 110 may be performed via a user interface generated by a printer driver of the driver module 120 of the host device 100.

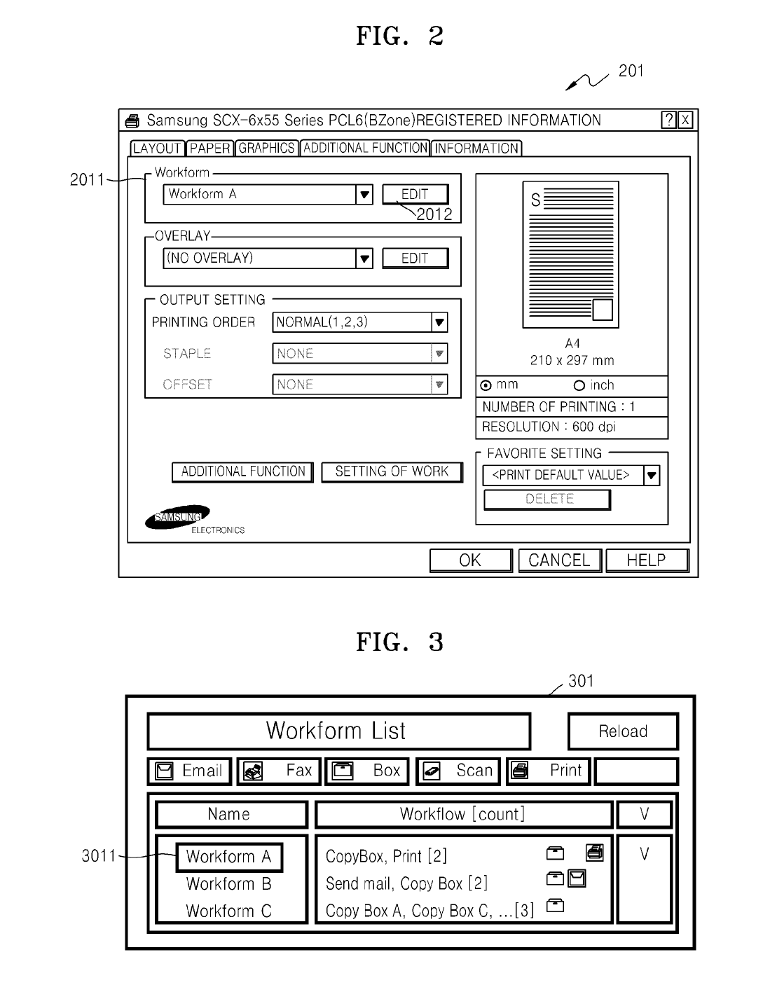

FIG. 2 illustrates an example of a user interface screen to provide a plurality of workforms according to exemplary embodiments of the present general inventive concept. In detail, FIG. 2 illustrates a printing option setting screen 201 which can be displayed on the user interface unit 110 of the host device 100 illustrated in FIG. 1. The printing option setting screen 201 can include a workform selection region 2011 to select workforms, and an “editing” region 2012 to edit operations defined in a workform. A user may select at least one workform from among a plurality of workforms displayed in the workform selection region 2011. Referring to FIG. 2, a “workform A” can be selected in the printing option setting screen 201. Also, the user may select the editing region 2012 and edit operations defined in the workform A.

FIG. 3 illustrates an example of a user interface screen in which a plurality of workforms can be edited according to exemplary embodiments of the present general inventive concept. In detail, FIG. 3 illustrates a workform editing screen 301 that can be displayed with the user interface unit 110 of the host device 100 illustrated in FIG. 1. In the workform editing screen 301, one or more workforms corresponding to user identification information, and a workflow indicating a list of operations defined in each of the workforms are displayed. For example, a “Workform A” 3011 can define “CopyBox” and “printing” operations. That is, if a user selects the “Workform A” 3011 when transmitting a document to be processed to the image forming apparatus 200, then the image forming apparatus 200 of FIG. 1 can store the document in a document box and can print the print data representing the document.

More specifically, documents can be classified according to attributes and can be stored in the document box (e.g., in storage unit 230). The image forming apparatus 200 can store a document received from the user in a document box (e.g., a predetermined storage area within the storage unit 230) corresponding to the user identification information, and can provide the stored document to the user so that the user can use the document at a desired point of time.

Thus, according to the “Workform A” 3011, a workflow can be defined. In this case, the workflow can indicate a list of operations to store a document received from the host device 100 in the document box of the host device 100, which corresponds to the identification information, and to print the document received from the host device 100.

Also, the user may edit workforms with the workform editing screen 301. Editing of workforms can include at least one selected from the group consisting of modifying, deleting, moving, and creating the workforms.

Modifying workforms can include modifying operations defined in each of the workforms. For example, a workform that can define a workflow indicating a list of operations, such as sending an email message and sending a facsimile message, may be modified to define a workflow indicating a list of operations, such as sending an email message and a printing operation by using the workform editing screen 301 illustrated in FIG. 3. Deleting workforms may include deleting a workform stored in the image forming apparatus 200. Moving workforms may include moving a workform listed in a list of workforms to another list of workforms. The workform may be moved by copying it to another list of workforms in the image forming apparatus 200. Also, creating workforms may include creating a new workform corresponding to the identification information, setting a workflow to be defined in the new workform, and storing the workform that defines the set workflow.

A user may conveniently perform a plurality of operations by using at least one workform that defines a plurality of operations that are frequently used. For example, a user may conveniently perform a plurality of operations (e.g., storing print data received from the host device 100 in a document box and printing the print data) by selecting the “Workform A” 3011 without having to manipulate the user interface unit 110 whenever each operation is performed. That is, the user interface 110 may receive a selection of a workform (e.g., Workform A 3011) and perform the plurality of operations included with the selected workform.

The “Workform A” 3011 is an example of a workform and various workforms may exist according to exemplary embodiments the present general inventive concept. Referring to FIG. 3, a “Workform B” can define a plurality of operations of attaching print data received from the host device 100 to an email message and sending the email message, and storing the print data in a document box (e.g., in a predetermined area of the storage unit 230).

FIGS. 2 and 3 illustrate examples of a user interface that can be generated by the print driver of the driver module 120, and such user interfaces via which workforms that can be displayed, selected, and edited may be executed using an application program. That is, a user may select and edit at least one workform from among a plurality of workforms displayed on a user interface with an application program.

Referring to FIG. 1, the user interface unit 110 may display the result of performing an operation in the image forming apparatus 200. The result of performing the operation may indicate at least one of notification that the operation is completed, the operation is being performed, and an error occurs during performing of the operation.

Completing the operation can include that the operation is completed according to commands given by the host device 100, that the operation is being performed can include that the operation is being performed according to the commands, and that an error occurs can include that an error occurs during performing of the operation according to the commands and the operation is thus stopped.

The driver module 120 can include at least one program to control the image forming apparatus 200. According to exemplary embodiments of the present general inventive concept the driver module 120 can include a printer driver, a scan driver, a fax driver, and so on. As described above, the printer driver can convert a document created according to an application in the host device 100 into print data that the image forming apparatus 200 can interpret, so that the document may be printed in the image forming apparatus 200. Examples of the printer driver include a graphics device interface (GDI) driver, a PostScript driver, a printer command language (PCL) driver, and an eXtensible Markup Language (XML) paper specifications (XPS) driver.

That is, the printer driver of the driver module 120 can generate one or more commands to perform operations defined in a workflow of a workform to be performed. The commands may be generated in a printer language and/or any other suitable language to carry out the exemplary embodiments of the present general inventive concept. For convenience of explanation, it is assumed that the printer driver of the driver module 120 is a PCL driver. The PCL driver can support a printer job language (PJL). For example, when a user inputs ID “AAA” via the user interface unit 110, the printer driver of the driver module 120 may generate, for example, commands, e.g., “@PJL USERID=AAA”, and transmit the commands to the image forming apparatus 200 via the communication interface unit 140. The image forming apparatus 200 may perform operations requested by the host device 100 according to the commands.

The commands according to exemplary embodiments of the present general inventive concept can be created in a PJL format, but the present general inventive concept is not limited thereto and the commands may be created using one or more printer languages.

The host device 100 may generate a command indicating user identification information and commands that instruct operations to be performed according to a workflow defined in a workform by using the printer driver of the driver module 120.

Also, according to exemplary embodiments of the present general inventive concept, the printer driver of the driver module 120 may include a web application to control the image forming apparatus 200. The web application may provide a web user interface (UI) to control the image forming apparatus 200. The host device 100 may select a printing option with a web UI provided from the printer driver (e.g., from the driver module 120). That is, the web UI may receive one or more selections (e.g., from a user) to control the image forming apparatus 200.

Referring to FIG. 1, the processor 130 can control the image forming apparatus 200 with the host device 100. That is, the processor 130 can execute the printer driver of the driver module 120 and display a user interface of the printer driver on the user interface unit 110. Also, the processor 130 may control the operations of the host device 100.

That is, the processor 130 can select a document to be processed and can select at least one workform from among a plurality of workforms corresponding to the user identification information displayed on the user interface unit 110, according to information received via the user interface unit 110.

The communication interface unit 140 can transmit data to and receive data from the image forming apparatus 200 via a network. In exemplary embodiments of the present general inventive concept, the network can include both a wireless network and a wired network that uses, for example, a universal serial bus (USB) cable. The network may be the Internet, a local area network (LAN), a wireless LAN, or a wide area network (WAN), but it would be apparent to those of ordinary skill in the art that the network is not limited thereto, provided it can transmit and receive information.

The host device 100 can transmit the user identification information to the image forming apparatus 200, receive workforms corresponding to the user identification information, and transmit commands that instruct operations defined in one of the workforms be performed via the communication interface unit 140. That is, the communication interface unit 140 may transmit a document to be processed, and print data that includes commands that at least one operation be performed on the document, to the image forming apparatus 200. The host device 100 and the image forming apparatus 200 may transmit data to and receive data from each other according to a driver and an emulator that are used with the host device 100 and the image forming apparatus 200. For example, the host device 100 and the image forming apparatus 200 may transmit data to and receive data from each other with PJL commands.

A user may control a plurality of operations to be performed in the image forming apparatus 200. The image forming apparatus 200 can receive the user identification information and receive a selection of at least one of the workforms corresponding to the user identification information, by using either the printer driver or an application program in the host device 100. That is, the user may conveniently perform a plurality of operations by selecting a workform without having to input commands for the respective operations individually. Also, the user may conveniently set a work environment to perform operations that are frequently performed in the image forming apparatus 200 by either creating a workform including frequently performed operations and/or by modifying the existing workform.

The image forming apparatus 200 can include a communication interface unit 210, a controller 220, a storage unit 230, a user interface unit 240, an authentication unit 251, a determination unit 252, and an operation performing unit 260. The operation performing unit 260 can include an image forming unit 261, a facsimile unit 262, and a transmission performing unit 263.

The image forming apparatus 200 can be connected to at least one host device 100 in a wired an/or wireless manner and can support at least one operation selected from the group consisting of printing, scanning, copying, sending or receiving a facsimile message, sending an email message, and transmitting data to a server (e.g., a host device communicatively coupled to the image forming device 200 via a wired and/or wireless network). When a plurality of operations are performed in the image forming apparatus 200, user convenience can be increased with a workform that defines a workflow indicating a list of operations that are frequently performed by a user. A workform that defines a workflow indicating a list of operations to be performed will now be described in detail.

The image forming apparatus 200 may store a plurality of pieces of user identification information for a plurality of respective users, and program files, e.g., script files, which can be used to create workforms corresponding to the respective pieces of user identification information. For example, a workform may be a template written in a script language. The scripting language can perform an operation defined in an application program according to a user demand (e.g., an input selection received by the user interface unit 110). The template can be configured in a predetermined format to process data and can be used to process data in the format when the user inputs the data.

The image forming apparatus 200 may edit workforms (e.g., create, modify, move, or delete the workforms) by receiving input information from a user and running a program file to create workforms according to the input information.

In detail, a user may create a workform to define a workflow indicating a plurality of operations to be performed, by manipulating the user interface unit 240 of the image forming apparatus 200.

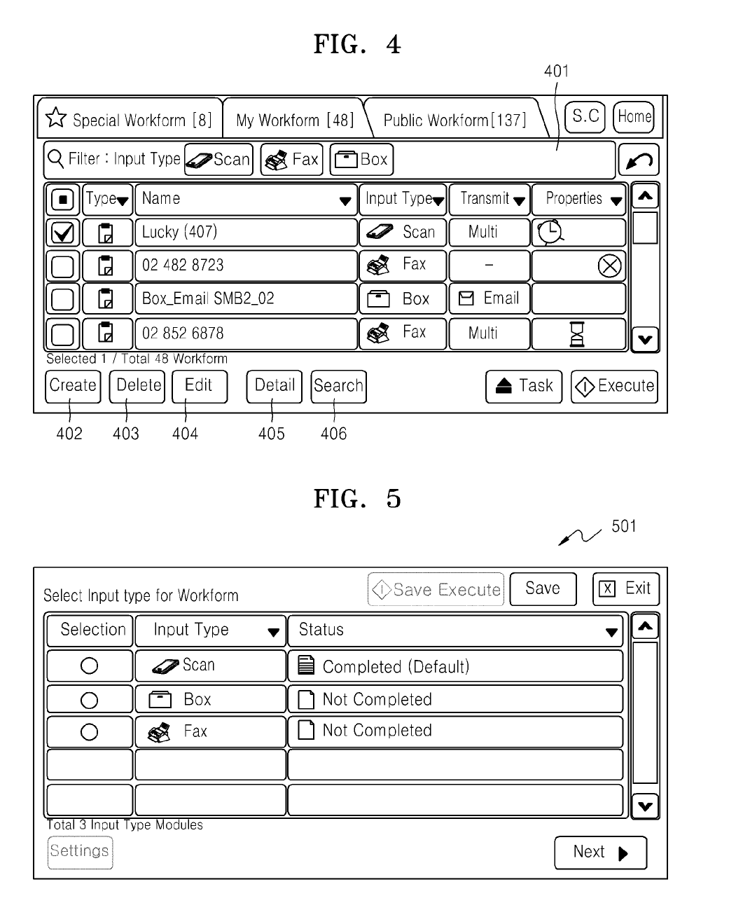

FIG. 4 illustrates an example of a graphics user interface (GUI) of the image forming apparatus 200 of FIG. 1, via which a workform is created, according to exemplary embodiments of the present general inventive concept. Referring to FIG. 4, a workform list 401, a workform creation icon 402, a workform deletion icon 403, a workform editing icon 404, a workform related detail information search icon 405, a workform search icon 406, and a workform 407 entitled “lucky” are displayed in the GUI. In exemplary embodiments of the present general inventive concept, the GUI is a user interface that is graphically configured with icons, characters, symbols, and so on. The GUI of FIG. 4 may be displayed on the user interface unit 240. A user may input information to be selected, for example, by touching the icons displayed on the user interface unit 240. Such a GUI may also be displayed as a web UI on the host device 100 of FIG. 1, which is connected to the image forming apparatus 200.

The workform list 401 can present information regarding a list of workforms created and stored in the image forming apparatus 200. For example, the workform list 401 can present the types, names, input types, output modules and properties of the workforms. For example, the type of the workform 407 entitled “lucky” is ‘public’, the name of the workform 407 is ‘lucky’, the input type of data needed to perform operations defined in the workform 407 is ‘scan data’, the output module of the data to perform the operations defined in the workform 407 is ‘multiple’, and the performing properties of the workform 407 includes the operations to be performed at a predetermined schedule time.

The types of workforms may be categorized into public workforms that are provided to one or more users (e.g., all users) of the image forming apparatus 200 and private workforms that are provided to a user corresponding to the user identification information.

The input types of data to perform operations defined in a workform may be categorized into print data transmitted from the host device 100, facsimile data transmitted from a facsimile, scan data scanned by the image forming apparatus 200, and data received from a document box storing documents, according to operations performed in the image forming apparatus 200.

The output modules of data to perform operations defined in a workform may be categorized into performing a print job, sending an email message, transmitting data to a server (Server Message Block/File Transfer Protocol), transmitting a facsimile message, and storing data in a document box corresponding to either the attributes of the data or the properties of the workform.

It is possible to assign a plurality of input types and a plurality of output modules to data needed to perform operations defined in one workform. In this case, the input types and the output modules of the workform may be indicated as ‘multiple’ in the workform list 401. For example, a workform may be defined such that scan data or print data that is received from the host device 100 is transmitted via email to a designated address and is stored in a document box corresponding to the attributes of the data, thereby performing a plurality of_operations associated with workforms having a plurality of input types and a plurality of output modules.

The performing properties of a workform may be determined such that operations defined in the workform are performed at a predetermined scheduled time. In this case, the workform may be retained in the image forming apparatus 200 after the operations are performed or may be deleted from the image forming apparatus 200 after the operations are performed once. Also, when the setting of the workform is not sufficient, e.g., when the output module of data needed to perform operations defined in the workform is not designated, the performing properties of a workform may indicate this fact.

The above types, names, input types, output modules, and properties of workforms are provided as examples, and thus, the workform list 401 may be displayed in various ways and operations defined in the workforms may be performed in various ways according to exemplary embodiments of the present general inventive concept as disclosed herein.

When a user selects the workform creation icon 402, a screen in which a workform is generated can be displayed on the user interface unit 240. The user may set the type, name, input type, output module, and properties of workforms by using the screen.

FIG. 5 illustrates an example of a GUI of the image forming apparatus 200 of FIG. 1, in which an input type of data needed to perform operations defined in a workform is selected, according to exemplary embodiments of the present general inventive concept. Referring to FIG. 5, an input type selection screen 501 is illustrated as an example of the GUI. In the input type selection screen 501, the input types of data needed to perform operations are displayed. For example, scan data scanned by the image forming apparatus 200, data stored in a document box, and facsimile data received from a facsimile may be selected as the input types of the data needed to perform the operations defined in the workform. In this case, a message inquiring whether additional information is needed is displayed in a “status” region of the input type selection screen 501.

For example, referring to FIG. 5, additional information may not be needed in the case of the scan data but additional information may be needed in the case of the data stored in the document box and the facsimile data. In the case of the data stored in the document box, additional information may be needed to select at least one document box from among a plurality of document boxes. In the case of the facsimile data, additional information may be needed to select the numbers of a facsimile which the facsimile data is transmitted from.

Thus, if a “document box A” is set using the input type selection screen 501 illustrated in FIG. 5 to define the input types of data needed to perform operations defined in a workform, then the workform may be defined such that the operations defined in the workform are performed using input data as data stored in the “document box A”.

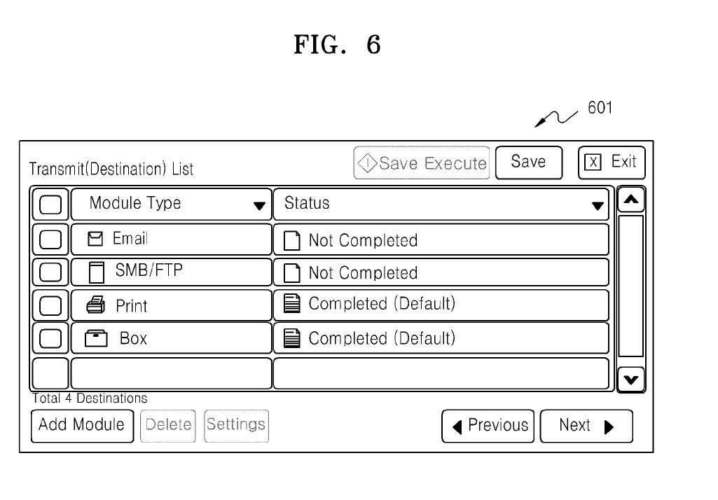

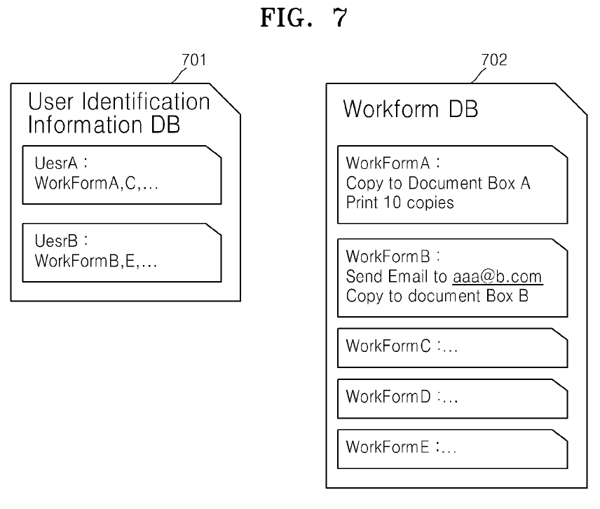

FIG. 6 illustrates an example of a GUI of the image forming apparatus 200 of FIG. 1, in which an output module of data to perform operations defined in a workform is selected, according to exemplary embodiments of the present general inventive concept. Referring to FIG. 6, an output module selection screen 601 is illustrated as an example of the GUI. In the output module selection screen 601, output modules of data to perform operations defined in a workform can be displayed. For example, operations such as transmitting an email message, transmitting data to a server (SMB/FTP), a print job, and storing data in a document box, may be selected as output modules of data needed to perform operations defined in a workform. In this case, a message inquiring whether additional information is needed is displayed in a “status” region of the output module selection screen 601.

For example, in the case of the print job, additional information may not be needed. To store data in a document box, additional information may not be needed to store data in a document box corresponding to the properties of a workform. To transmit an email message and/or transmit data to a server (SMB/FTP), additional information may be needed to set the address of a destination and so on.

Thus, if the print job is set as an output module to perform operations defined in a workform with the output module selection screen 601 illustrated in FIG. 6, then the workform may be defined to perform the print job with input data.

A user may use a workform to perform a plurality of operations that are frequently performed. The workform may define operations according to output modules with one or more input data as illustrated in FIGS. 5 and 6. Accordingly, the user may select information for a workform to define various operations that may be performed using the image forming apparatus 200.

Referring to FIG. 4, if a user selects the workform deletion icon 403, a workform selected by the user from among a plurality of workforms included in the workform list 401 can be deleted.

When the user selects the workform editing icon 404 of FIG. 4, the workform selected from the workform list 401 may be edited. A screen to edit the workform may be provided, and the user may edit the type, name, input type, output module, and properties of the selected workform by using this screen.

When the user selects the workform related detail information search icon 405 of FIG. 4, one or more details of the workform selected from the workform list 401 may be displayed. The details may include, for example, a list of operations defined in the workform and the characteristics of the defined operations.

If the user selects the workform search icon 406 of FIG. 4, a screen to search for a desired workform may be provided. The user may input information regarding the desired workform to the image forming apparatus 200. The input information of the workform may be, for example, the name, input type, and output module of the workform. For example, if the user selects the workform search icon 406 and inputs the input types of the desired workform, e.g., ‘scan data’, ‘facsimile data’, and ‘data stored in a document box’, as the information regarding the desired workform, then the workform list 401 illustrated in FIG. 4 may be displayed as the result of the search.

In exemplary embodiments of the present general inventive concept, the GUI may be a user interface that is graphically configured with icons, characters, symbols, and so on. The screens of the exemplary embodiments of the present general inventive concept illustrated in FIGS. 4 to 6 may be displayed on the user interface unit 240 of FIG. 1. The screens may be displayed as a web UI or a user interface of the host device 100 connected to the image forming apparatus 200, and information input as described above may be input from the host device 100 to the image forming apparatus 200. The screens illustrated in FIGS. 4 to 6 are exemplary embodiments of the present general inventive concept and various other screens may be used according to the present general inventive concept.

A workform that defines a workflow indicating a plurality of operations to be performed may be generated in the image forming apparatus 200 as described above. The generated workform may be managed to correspond to user identification information. The controller 220 of FIG. 1 can create a workform and manage it to correspond to user identification information.

FIG. 7 illustrates a database of user identification information and a database of workforms according to exemplary embodiments of the present general inventive concept. Referring to FIG. 1, the controller 220 may generate a database of user identification information and a database of workforms and store the databases in the storage unit 220. FIG. 7 illustrates a database 701 of user identification information and a database 702 of workforms.

The database 702 can include a list of workforms generated according to the methods described above with reference to FIGS. 4 to 6, and a workflow presenting a list of operations defined in each of the workforms. In the database 702, a “WorkFormA” defines that input data is to be stored in a document box A and a print job is to be performed on the input data ten times. That is, the database 702 can include a plurality of workforms, each defining a workflow to perform a plurality of operations.

The database 701 can include workforms corresponding to user identification information. In the database 701, the “WorkFormA” and a “WorkFormC” correspond to a “UserA”. A workform list may be referred to as a list of a plurality of workforms, such as the “WorkFormA” and the “WorkFormC”.

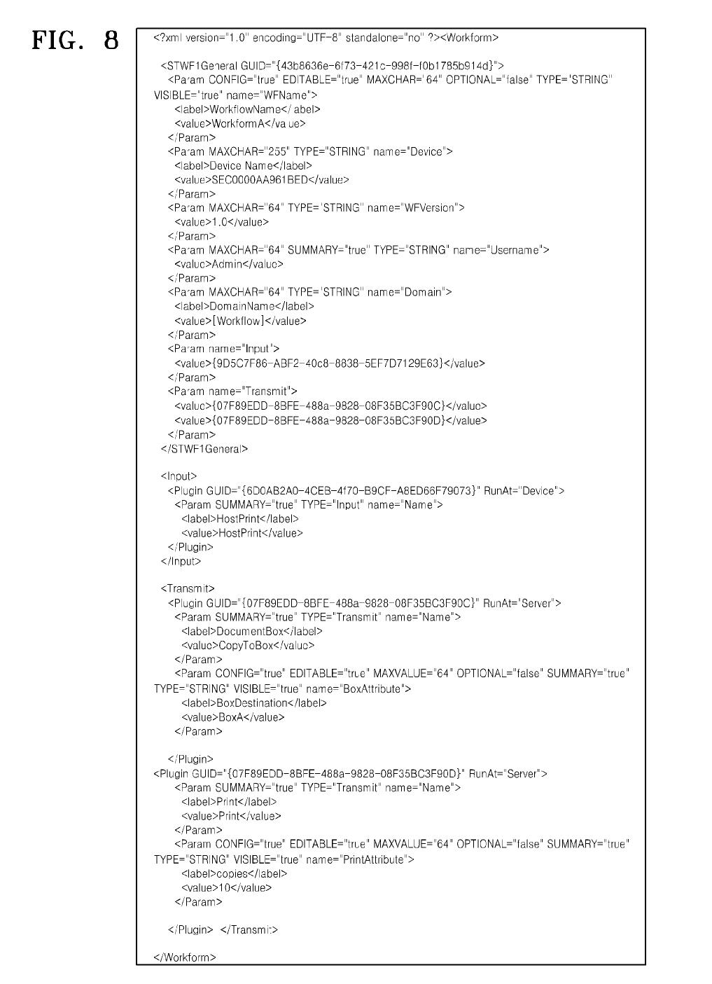

FIG. 8 illustrates the syntax of a program to generate a workform according to exemplary embodiments of the present general inventive concept. In detail, FIG. 8 illustrates a program of the “WorkFormA” included in the database 702 of workforms illustrated in FIG. 7. The controller 220 of FIG. 1 may use the program illustrated in FIG. 8 to create a workform that defines a workflow indicating a list of operations according to information provided by a user (e.g., information received by the user interface unit 110 illustrated in FIG. 1). In the program of FIG. 8, the “WorkFormA” can be defined such that input data is to be stored in a document box A and a print job is to be performed on the input data ten times. It would be apparent to those of ordinary skill in the art that the program illustrated in FIG. 8 illustrates an example of a method of generating a workform according to the present general inventive concept, and that a workform may be generated in various other ways.

A method of performing at least one operation defined in a workform as described above in the image forming apparatus 200 of FIG. 1 according to exemplary embodiments of the present general inventive concept will now be described.

Referring to FIG. 1, the communication interface unit 210 can receive user identification information and provide a user with at least one workform corresponding to the user identification information. The communication interface unit 210 may also receive a document on which operations defined in the at least one workform are to be performed, from the host device 100.

The communication interface unit 210 may be a modem used to send and receive a facsimile message, a network module to access a network, or a USB host module to establish a data movement channel with a movable storage medium.

The communication interface unit 210 can receive user identification information from the host device 100. As described above, the user identification information can include information to identify a user (e.g., an ID and password of the user) to distinguish the user from other users. The user identification information may be received from a user via the user interface unit 110 of the host device 100. Alternatively, the user identification information may be received by connecting the image forming apparatus 200 to the host device 100 and receiving information of the user from the host device 100. That is, the user identification information may be received without the user's manipulation. Alternatively, user identification information may be received from one or more host devices communicatively coupled to a communications network that the image forming apparatus 200 is also communicatively connected to.

The communication interface unit 210 can provide the user with a workform corresponding to the received identification information. That is, the authentication unit 251 can authenticate the received identification information according to user identification information that has been stored in the image forming apparatus (e.g., information stored in the storage unit 230). The determination unit 252 can determine whether there is a workform corresponding to the authenticated identification information. The controller 220 can transmit at least one workform corresponding to the authenticated user identification information to the host device 100 via the communication interface unit 210, according to the result of determination.

The communication interface unit 210 may receive a document on which an operation is to be performed, and may receive print data that includes commands that instruct at least one operation be performed on the document. In this case, the document may include print data.

The document may include print data received from the host device 100, facsimile data received from a facsimile, scan data scanned by the image forming apparatus 200, and so on.

The controller 220 can control the operations of the image forming apparatus 200. That is, the controller 220 can control the operations of at least one of the communication interface unit 210, the storage unit 230, the user interface unit 240, the authentication unit 251, the determination unit 252, the operation performing unit 260, the image forming unit 261, the facsimile unit 262, and the transmission performing unit 263.

The authentication unit 251 can authenticate the user identification information received from the host device 100 according to the user identification information stored in the storage unit 230. The determination unit 252 can determine whether a workform corresponding to the authenticated identification information is stored in the storage unit 230.

That is, user identification information registered with the image forming apparatus 200 may be added to a user identification information database stored in the storage unit 230, and thus, the authentication unit 251 may authenticate the user identification information according to the database 701 of user identification information. If the user identification information database includes identification information that matches the user identification information, then the user corresponding to the user identification information is authenticated.

The determination unit 252 may determine if there is a workform corresponding to the user identification information authenticated by the authentication unit 251 according to the database 702 of workforms. That is, the determination unit 252 can determine whether a workform matching the authenticated user identification information is included in the database 702, and the controller 220 can provide the user with the workform corresponding to the authenticated identification information according to the determination result of the determination unit 252.

The controller 220 can perform operations defined in a workform according to the user's response to the workform. The user's response may be received from the host device 100, or may be received directly from the user via the image forming apparatus 200. For example, the user may allow operations defined in a workform to be performed, by either selecting the workform via the user interface unit 240 of the image forming apparatus 200 or selecting the workform via the user interface unit 110 of the host device 100.

The controller 220 can control the image forming apparatus 200 to perform the operations defined in the workform selected by the user. Alternatively, the controller 220 may allow workforms, which correspond to the attributes of scan data, print data received from the host device 100, and facsimile data received from a facsimile, to be extracted and operations defined in the workforms to be performed by using the extracted data.

For example, the controller 220 may refer to the attributes of facsimile data received via the communication interface unit 210. The attributes of the facsimile data may be the numbers of a facsimile that transmitted the facsimile data or the name of a receiver of the facsimile data. The determination unit 252 can determine whether a workform that defines a workflow corresponding to the attributes of the facsimile data is included in the database 702 of workforms stored in the storage unit 230. If the determination unit 252 determines that the workflow corresponding to the attributes of the facsimile data is included in the database 702, for example, if input data is the facsimile data and the numbers of the facsimile that transmitted the facsimile data are the same as those of a facsimile that is defined in the attributes of the facsimile data, then the controller 220 can control the image forming apparatus 200 to perform the operations defined in the workform.

The operations defined in the workform may include operations to be performed according to the workflow defined in the workform. The operations may store the facsimile data in a document box (e.g., a predetermined area of the storage unit 220) or to print the facsimile data according to the workflow.

The controller 220 may store data which is received via the communication interface unit 210 in a document box corresponding to the attributes of the received data, as defined in the workform.

For example, to perform the operations defined in the workform, the controller 220 may control a document received via the communication interface unit 210 to be stored in a document box corresponding to the attributes of the document. Specifically, when the image forming apparatus 200 receives print data from the host device 100, the controller 220 may control the print data to be stored in a document box corresponding to the attributes of the print data, according to the attributes of the print data. That is, when print data is transmitted from the host device 100 of a user A to the image forming apparatus 200, the controller 220 may store the print data in a document box corresponding to the user A.

Accordingly, a user may conveniently perform a plurality of operations with at least a workform and a document box. Also, the user may conveniently perform at least one operation with a workform, regardless of whether the image forming apparatus 200 supports a document box function. That is, even if the image forming apparatus 200 does not support the document box function, the user may perform a plurality of operations by using workforms, with each defining a workflow that indicates a list of a plurality of operations to be performed and by manipulating the image forming apparatus 200 or the host device 100.

The storage unit 230 may store a user identification information database, a workform database, and any other suitable information to carry out the exemplary embodiments of the present general inventive concept as disclosed herein. The storage unit 230 may store document boxes according to the function (e.g., the selected function such as printing, scanning, faxing, etc.) of the image forming apparatus 200.

In the exemplary embodiments of the present general inventive concept, the storage unit 230 can be a general storage medium and it would be apparent to those of ordinary skill in the art that examples of the storage unit 230 include a hard disk drive (HDD), a solid state drive (SSD), a random access memory (RAM), a flash memory, a memory card, and/or any other suitable storage device to carry out the exemplary embodiments of the present general inventive concept as disclosed herein.

The user interface unit 240 can receive an input signal from a user and display output information so that the user can view it. Examples of the user interface unit 240 include input/output devices such as a display panel, a mouse, a touch screen, a monitor, a speaker, and/or any suitable combination thereof in order to carry out the exemplary embodiments of the present general inventive concept which may be included in the image forming apparatus 200. The user may create, edit, and/or delete a workform by manipulating the user interface unit 240.

The user interface unit 240 may display the result of performing an operation in the image forming apparatus 200. The result of performing the operation may indicate that the operation is completed, that the operation is being performed, and that an error occurred while the operation is being performed.

The operation performing unit 260 can perform at least one operation on a document to be processed when controlled, for example, by the controller 220. That is, the image forming unit 261 may print the document, the facsimile unit 262 may transmit the document via facsimile, and the transmission performing unit 263 may transmit the document via email or to a server. The controller 220 may perform data processing in order to perform the above operations. For example, the controller 220 may perform data processing to convert print data stored in the image forming apparatus 200 into facsimile data so that the print data can be transmitted via facsimile.

The image forming unit 261 can perform image forming on a document to be processed. Thus, the image forming unit 261 can print the print data representing the document onto printing paper.

Also, the facsimile unit 262 and the transmission performing unit 263 may perform various operations of the image forming apparatus 200. The facsimile unit 262 may transmit a document via facsimile and the transmission performing unit 263 may transmit the document to an external device, e.g., a server, a movable storage medium, or a computer system.

The above operations, such as printing, transmitting a document via facsimile, and transmitting the document to an external device, are just examples of operations that may be performed according to exemplary embodiments of the present general inventive concept, and the present general inventive concept is not limited thereto and the image forming apparatus 200 according to exemplary embodiments of the present general inventive concept may perform various other functions.

In the image forming system illustrated in FIG. 1 that includes the host device 100 and the image forming apparatus 200, the host device 100 and the image forming apparatus 200 may transmit data to and receive data from each other via a wired network, e.g., a USB cable, or a wireless network. Also, the image forming system may transmit and receive data, for example, by using PJL commands, regardless of whether a network employed is a wired or wireless network.

When a USB cable is used, the host device 100 and the image forming apparatus 200 may use a control channel and a data channel according to USB protocols.

If a control channel is used to transmit data to and receive data from the communication interface unit 140 of the host device 100 and the communication interface unit 210 of the image forming apparatus 200, then the host device 100 transmits a USB request command to the image forming apparatus 200 by using a “control endpoint” defined in the USB protocols and the image forming apparatus 200 provides the host device 100 with a workform according to the USB request command.

If a data channel is used to transmit data to and receive data from the communication interface unit 140 of the host device 100 and the communication interface unit 210 of the image forming apparatus 200, then the image forming apparatus 200 can analyze a command received from the host device 100 and provide the host device 100 with a workform according to the command.

If a wireless network is used in order to transmit data to and receive data from the communication interface unit 140 of the host device 100 and the communication interface unit 210 of the image forming apparatus 200, then the image forming apparatus 200 may provide the host device 100 with workforms by using a URL that is predetermined between the host device 100 and the image forming apparatus 200.

In the image forming system, a method of transmitting data to and receiving data from the host device 100 and the image forming apparatus 200 would be apparent to those of ordinary skill in the art and is thus not described here.

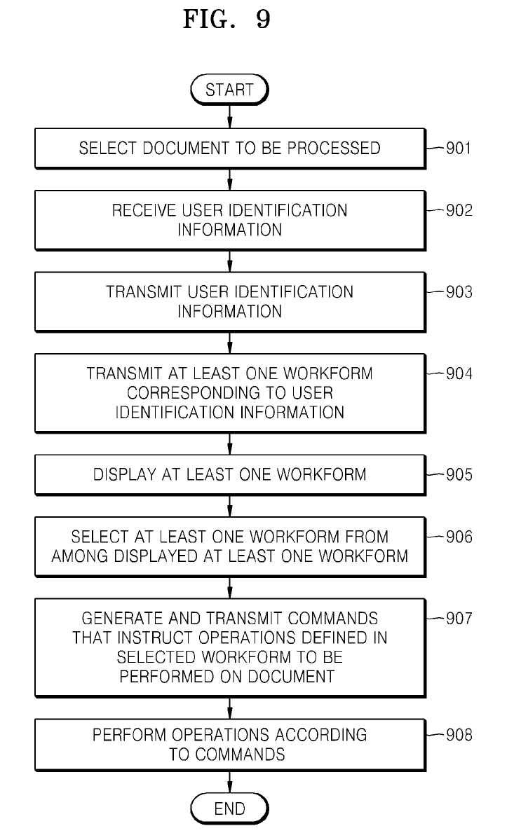

FIG. 9 is a flowchart illustrating a method of performing at least one operation in an image forming apparatus, according to exemplary embodiments of the present general inventive concept. The method of FIG. 9 includes a plurality of operations that are performed sequentially in the image forming system illustrated in FIG. 1. Thus, although not described here, the above description of the image forming system of FIG. 1 can also be applied to the method of FIG. 9.

Referring to FIGS. 1 and 9, in operation 901, a user can select a document to be processed via the user interface unit 110 of the host device 100. That is, the user interface 110 receives a document selection from a user. The document may be any type of document that can be processed according to an application program installed and executed by the host device 100.

In operation 902, the user can input the user identification information via the user interface unit 110 of the host device 100. The user identification information may be input using either a printer driver of the image forming apparatus 200 or an application program. For example, the user identification information may be input by logging into the image forming apparatus 200.

In operation 903, the communication interface unit 140 of host device 100 can transmit the user identification information to the image forming apparatus 200, and the communication interface unit 210 of the image forming apparatus 200 can receive the user identification information.

In operation 904, at least one workform corresponding to the identification information transmitted to the image forming apparatus 200 can be provided to the user. The authentication unit 251 can authenticate the received user identification information. The determination unit 252 can determine whether the at least one workform corresponding to the authenticated identification information is present. When it is determined that at least one workform corresponding to the authenticated identification information is present, the controller 220 can transmit the at least one workform to the host device 100 via the communication interface unit 210.

In operation 905, the host device 100 can receive the at least one workform corresponding to the authenticated identification information and can display it via the user interface unit 110. In this case, the at least one workform corresponding to the authenticated user identification information may be displayed using, for example, either a user interface of the printer driver of the image forming apparatus 200 or a user interface of an application program.

In operation 906, the user can select at least one workform from among the at least one workform displayed on the user interface unit 110.

In operation 907, the processor 130 can generate commands that instruct operations defined in the selected workform be performed on the document, and the communication interface unit 140 can transmit the commands to the image forming apparatus 200.

In operation 908, the operation performing unit 260 of the image forming apparatus 200 can perform the operations according to the received commands. That is, the document may be printed, may be transmitted via facsimile, or may be transmitted to an external device.

Accordingly, the method of FIG. 9 allows a user to conveniently perform a plurality of operations, which are frequently used, with a workform corresponding to the user identification information. When the image forming apparatus 200 supports a document box function, the user may store a document in a document box corresponding to the user identification information by using the workform. When the image forming apparatus 200 does not support the document box function, the user may perform a plurality of operations by using the workform and by simply manipulating the image forming apparatus 200 or the host device 100. Also, the host device 100 may control the image forming apparatus 200 to perform a plurality of operations, which are frequently used, by using a workform.

In exemplary embodiments of the present general inventive concept, the host device 100 illustrated in FIG. 1 and disclosed in detail above can generate a list of workforms to perform a series of operations (e.g., one or more operations) at least according to the list of operations in each workform. That is, the host device can receive one or more selections of workforms to generate a list of workforms, or may generate a predetermined list of workforms according to at least one of a selected document, a received operation and/or command, and/or any other suitable input in order to carry out exemplary embodiments of the present general inventive concept. The host device 100 can provide the generated list of workforms to the image forming apparatus 200 via the communication interface 140 and a communications link (e.g., a wired and/or wireless communication network) with the communication interface 210 of the image forming apparatus 200.

In exemplary embodiments of the present general inventive concept, the image forming apparatus 200 illustrated in FIG. 1 and disclosed in detail above may receive a generated list of workforms from the host device 100 via the communication interface unit 210. The controller 220 can control the operation performing unit 260 to perform the one or more operations in each of the workforms for the list of workforms. The workforms can include a first operation, and a second operation to be performed simultaneously and/or after the first operation. For example, the operation performing unit 260 of the image forming apparatus 200 can perform the first operation when the list of workforms has been received from the host device 100, and can perform the second operation, for example, when the first operation is being performed or after the first operation has been performed. In exemplary embodiments of the present general inventive concept, the first operation and the second operation may be operations of the same workform in the received list of workforms, or can be in different workforms in the received list of workforms.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to the exemplary embodiments of the present general inventive concept, at least one operation may be conveniently performed in an image forming apparatus by using a workform corresponding to user identification information. Also, a host device may control the image forming apparatus to perform at least one operation by using the workform.

While the present general inventive concept has been particularly illustrated and described with reference to exemplary embodiments thereof, it will be understood by those of ordinary skill in the art that various changes in form and details may be made therein without departing from the spirit and scope of the present general inventive concept as defined by the following claims.

What is claimed is:

1. A method of performing at least one operation by using a workform that defines a workflow indicating a list of operations to be performed in an image forming apparatus to be connected to a host device, the method comprising:
selecting a document to be processed;
receiving user identification information of who is to perform the at least one operation on the selected document;
receiving at least one workform corresponding to the received identification information from the image forming apparatus;
displaying the received at least one workform;
selecting at least one workform from among the displayed at least one workform according to received information; and
performing an operation according to a workflow defined in the selected at least one workform on the document in the image forming apparatus.

2. The method of claim 1, wherein the receiving of the user identification information comprises:
receiving the user identification information with either a printer driver of the image forming apparatus or an application program which is installed in the host device.

3. The method of claim 1, wherein the at least one workform comprises:
at least one selected from the group of a workform list mapped to the user identification information from among workform lists of a plurality of workforms stored in the image forming apparatus, and a plurality of workforms stored in the image forming apparatus.

4. The method of claim 1, wherein the workform that defines the workflow is edited according to the received information,
wherein the editing of the workform that defines the workflow comprises at least one selected from the group consisting of modifying, deleting, moving, and creating a new workform.

5. The method of claim 1, wherein the displaying of the at least one workform comprises:
displaying the at least one workform by using either a user interface of a printer driver of the image forming apparatus or a user interface of an application program, which is installed in the host device.

6. The method of claim 5, wherein the displayed at least one workform is edited according to the information input,
wherein the editing of the displayed at least one workform comprises at least one selected from the group consisting of modifying, deleting, moving, and creating a new workform.

7. The method of claim 1, further comprising displaying the result of performing the operation according to the workflow defined in the selected workform,
wherein the result of performing indicates at least one selected from notifications that the operation is completed, that the operation is being performed, and that an error has occurred during performing of the operation.

8. The method of claim 1, further comprising:
authenticating the received identification information by using user identification information stored in the image forming apparatus; and
determining whether a workform corresponding to the authenticated identification information is present,
wherein the receiving of the at least one workform comprises receiving the at least one workform corresponding to the authenticated identification information from the image forming apparatus according to the result of the determination.

9. An image forming apparatus to perform at least one operation by using a workform that defines a workflow indicating a list of operations to be performed, the image forming apparatus comprising:
a storage unit to store a plurality of pieces of identification information of a plurality of respective users and workforms corresponding to the pieces of the identification information;
a communication interface unit to receive user identification information to perform the at least one operation, and to transmit at least one workform corresponding to the received identification information from among the stored workforms;
a controller to control an operation according to a workflow defined in at least one workform selected from among the transmitted at least one workform; and
an operation performing unit to perform the operation on a document to be processed under control of the controller.

10. The image forming apparatus of claim 9, wherein the communication interface unit receives the document and print data that contains a command that instructs the operation be performed on the document, and
the operation performing unit performs the operation on the document according to the received print data.

11. The image forming apparatus of claim 9, further comprising:
an authentication unit to authenticate the received identification information with at least a portion of the identification information stored in the storage unit; and
a determination unit to determine whether a workform corresponding to the authenticated identification information is present,
wherein the controller controls a workform corresponding to the authenticated identification information to be transmitted according to the result of a determination of the determination unit.

12. The image forming apparatus of claim 9, wherein the operation performing unit further comprises:
an image forming unit to print the document;
a facsimile unit to transmit the document via facsimile; and
a transmission performing unit to transmit the document via email or to a server.

13. The image forming apparatus of claim 9, further comprising:
a user interface unit to receive the user identification information and displaying the at least one workform corresponding to the received user identification information,
wherein the controller controls an operation according to a workflow defined in at least one workform selected from among the displayed at least one workform.

14. The image forming apparatus of claim 13, wherein the user interface unit receives information to edit the displayed at least one workform,
wherein the editing of the displayed at least one workform comprises at least one selected from the group consisting of modifying, deleting, moving, and creating a new workform.

15. The image forming apparatus of claim 9, wherein the storage unit stores at least one document box, and
the controller stores the document in a document box corresponding to attributes of the document.

16. A host device to control an image forming apparatus which performs at least one operation by using a workform that defines a workflow indicating a list of operations to be performed, the host device comprising:
a user interface unit to receive user identification information to perform the at least one operation, and to display at least one workform corresponding to the received user identification information;
a processor to execute a printer driver of the image forming apparatus, and to select a document, which is to be processed, and at least one workform from among the displayed at least one workform, according to received information; and
a communication interface unit to transmit a command that instructs an operation be performed on the selected document according to a workflow defined in the selected at least one workform.

17. The host device of claim 16, wherein the user interface unit obtains information to edit the displayed at least one workform,
wherein the editing of the displayed at least one workform comprises at least one selected from the group consisting of modifying, deleting, moving, and creating a new workform.

18. A method of performing a least one operation with an image forming apparatus, the method comprising:
receiving a selection to generate at least one workform that includes a workflow of one or more operations to be performed by at least the image forming apparatus;
receiving at least one of an add, modify, and delete command to edit the one or more operations of the workflow included in the generated workform;
receiving a selection of a document with the image forming apparatus; and
performing the one or more operations included in the edited workflow of the selected workform on the selected document.

19. A method of controlling a least one operation of an image forming apparatus with a host apparatus, the method comprising:
receiving a selection of a document with the host apparatus;
receiving a selection of at least one workform that includes a workflow of one or more operations with the host apparatus to be performed by at least the image forming apparatus; and
controlling the image forming apparatus with the host apparatus to perform the one or more operations included in the workflow of the selected workform on the selected document.

20. A method of controlling an image forming apparatus to perform one or more operations, the method comprising:
receiving a list of workforms with a communication interface unit of the image forming apparatus;
performing one or more operations with an operation performing unit of the image forming apparatus; and
controlling the operation performing unit with a control unit to perform subsequent operations of the respective workforms according to the list.
